(19) United States
(12) Patent Application Publication
(10) Pub. No.: US 2009/0305714 A1
(43) Pub. Date: Dec. 10, 2009

(54) Wireless Communication System, Wireless Communication Terminal, Base Station and Wireless Communication Method

(75) Inventors: Hironobu Tanigawa, Tokyo (JP); Yasuhiro Nakamura, Yokohama-shi (JP); Nobuaki Takamatsu, Yokohama-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/442,450

(22) PCT Filed: Sep. 14, 2007
(86) PCT No.: PCT/JP2007/067993

§ 371 Date: Jul. 24, 2009

(30) Foreign Application Priority Data
Sep. 25, 2006 (JP) 2006-259075

(51) Int. Cl. H04W 72/00; H04M 1/00

(52) U.S. Cl. 455/450; 455/550.1

(57) ABSTRACT

Provided is a wireless communication system in which a plurality of channels are shared and one of the channels is adaptively allocated to a wireless communication terminal by a base station. The wireless communication terminal is provided with a channel requesting unit that requests the base station to allocate an individual control channel when a communication request is received from an upper control unit of its own terminal or the base station, and a state control unit that controls the state of its own terminal so that the state transits to an individual control channel connected state in which control information is transmitted/received by wirelessly connecting the individual control channel allocated from the base station. The base station is provided with a channel allocating unit that allocates one of a plurality of traffic channels as the individual control channel to be exclusively used for the wireless communication terminal in response to the request from the wireless communication terminal.

### TECHNICAL FIELD

The present invention relates to a wireless communication system, a wireless communication terminal, a base station, and a wireless communication method.

Priority is claimed on Japanese Patent Application No. 2006-259075, filed Sep. 25, 2006, the content of which is incorporated herein by reference.

### BACKGROUND ART

Conventionally, in a PHS (Personal Handyphone System), a wireless communication terminal (hereinafter, referred to as PHS terminal) performs communication while transiting a plurality of states such as an idle state, an active state, etc., according to a communication situation with a base station. Here, the idle state is a state (standby state) in which a connection with the base station is not established. Also, the active state indicates a state in which the connection with the base station is established and data communication is performed by wirelessly connecting a traffic channel (TCH) allocated from the base station through a control channel (CCH). The above-described idle state includes a dormant state (the state in which a connection and a wireless connection between the base station and the PHS terminal are terminated, but a connection between the PHS terminal and a server of a public line network is maintained).

When a communication request (a signal transmission request in the case of an upper control unit of its own terminal or a signal reception request in the case of the base station) is received from the upper control unit of its own terminal or the base station in the idle state, the PHS terminal transmits a link channel (LCH) allocation request to the base station through an upstream CCH and the base station transmits TCH allocation information to the PHS terminal through a downstream CCH as its response. Then, the PHS terminal transits to the active state and performs data communication with the base station by wirelessly connecting a TCH indicated by the TCH allocation information.

On the other hand, in recent years, communication systems adopting an OFDMA (Orthogonal Frequency Division Multiple Access) scheme as a multiple access technology have attracted attention as a next-generation broadband mobile communication system in addition to a TDMA (Time Division Multiple Access)/TDD (Time Division Duplex) scheme adopted by the conventional PHS. The OFDMA scheme is a technology that realizes multiple accesses by such means that a plurality of terminals share subcarriers in an orthogonal relationship (that is, mutual interference is absent in a correlation value of 0), a given plurality of subcarriers are positioned as subchannels, and the subchannels are adaptively allocated to each terminal at a given communication timing (this communication timing corresponds to a slot or the like. in a system adopting TDMA).

This next-generation broadband mobile communication system has an object of realizing the use efficiency improvement of wireless resources, maximization of data throughput, and high-speed and large-capacity data communication by allocating wireless resources according to a service class of QoS (Quality of Service) allocated to the terminal or communication quality between the base station and the terminal.

Non-Patent Document 1: “Second-generation cordless telephone system standard RCR STD-28” ARIB (Association of Radio Industries and Businesses)

Non-Patent Document 2: “WiMAX standard 802.16_{—}2004” WiMAX FORUM

### DISCLOSURE OF THE INVENTION

### Problem to be Solved by the Invention

However, when the same LCH allocation (that is, TCH allocation) process as in the above-described conventional PHS is adopted for the next-generation broadband mobile communication system, the following problems occur.

The conventional PHS promotes the reuse of wireless resources and the reduction of radio wave interference by performing distributed autonomous control so that channels to be used between base stations do not overlap. Thereby, accurate synchronous control between the base stations and between the base station and the PHS terminal is needed, but there is an advantage in that a cell design is facilitated and also a system extension is facilitated.

Since the CCH is shared by all base stations and all PHS terminals, the conventional PHS is characterized in that a period of timing at which one base station can use the CCH under the above-described distributed autonomous control is very long (about 100 ms). That is, when the LCH allocation process is performed, the PHS terminal first transmits an LCH allocation request to the base station through an upstream CCH, but the base station needs to wait until the use timing of the next CCH (down CCH) (after about 100 ms) so as to return its response to the PHS terminal.

When the LCH allocation (that is, TCH allocation) process is performed using the long-period CCH as described above, a wireless resource allocation period is lengthened. As a result, there is a problem in that the effect of use efficiency improvement of wireless resources desired by the next-generation broadband mobile communication system is degraded.

The present invention has been made in view of the above-described situation and an object of the invention is to promote the use efficiency improvement of wireless resources in a wireless communication system in which a plurality of channels are shared and one of the channels is adaptively allocated to a wireless communication terminal by a base station.

### Means for Solving the Problem

To accomplish the above-described object, the present invention provides a wireless communication system in which a plurality of channels are shared and one of the channels is adaptively allocated to a wireless communication terminal by a base station, the system including: the wireless communication terminal including: a channel requesting unit that requests the base station to allocate an individual control channel when a communication request is received from an upper control unit of its own terminal or the base station; and a state control unit that controls the state of its own terminal so that the state transits to an individual control channel connected state in which control information is transmitted/received by wirelessly connecting the individual control channel allocated from the base station; and the base station including: a channel allocating unit that allocates one of a plurality of traffic channels as the individual control channel to be exclusively used for the wireless communication terminal in response to the request from the wireless communication terminal.

As a typical example, the channel allocating unit may have a function that allocates a data communication traffic channel and transmits allocation information of the data communication traffic channel to the wireless communication terminal through the individual control channel, and the state control unit controls the state of its own terminal so that the state transits to a data communication state in which data communication with the base station is performed by wirelessly connecting a traffic channel indicated by the traffic channel allocation information obtained through the individual control channel when a data communication request is received from the upper control unit of its own terminal or the base station in the individual control channel connected state.

In this case, when the data communication with the base station ends in the data communication state, the state control unit may control the state of its own terminal so that the state transits to the individual control channel connected state.

Alternatively, when there is a termination request from the upper control unit of its own terminal or the base station in the data communication state, the state control unit may control the state of its own terminal so that the state transits to a standby state by terminating a wireless connection of the data communication traffic channel and a connection with the base station.

As a preferred example, when a predetermined time has elapsed without a data communication request from the upper control unit of its own terminal or the base station in the individual control channel connected state, the state control unit may control the state of its own terminal so that the state transits to a sleep state in which a wireless connection of the individual control channel is terminated while maintaining a connection with the base station.

As another preferred example, when there is a termination request from the upper control unit of its own terminal or the base station in the individual control channel connected state, the state control unit may control the state of its own terminal so that the state transits to a standby state by terminating a wireless connection of the individual control channel and a connection with the base station.

As another preferred example, when a communication request is received from the upper control unit of its own terminal or the base station in a sleep state or a standby state in which a connection with the base station is not established, the channel requesting unit may request the base station to allocate the individual control channel.

The present invention also provides a wireless communication terminal for performing communication by sharing a plurality of channels and adaptively allocating one of the channels from a base station, the terminal including: a channel requesting unit that requests the base station to allocate an individual control channel when a communication request is received from an upper control unit of its own terminal or the base station; and a state control unit that controls the state of its own terminal so that the state transits to an individual control channel connected state in which control information is transmitted/received by wirelessly connecting the individual control channel allocated from the base station.

As a typical example, when a data communication request is received from the upper control unit of its own terminal or the base station in the individual control channel connected state, the state control unit may control the state of its own terminal so that the state transits to a data communication state in which data communication with the base station is performed by wirelessly connecting a traffic channel indicated by traffic channel allocation information obtained through the individual control channel.

In this case, when the data communication with the base station ends in the data communication state, the state control unit may control the state of its own terminal so that the state transits to the individual control channel connected state.

Alternatively, when there is a termination request from the upper control unit of its own terminal or the base station in the data communication state, the state control unit may control the state of its own terminal so that the state transits to a standby state by terminating a wireless connection of the data communication traffic channel and a connection with the base station.

As a preferred example, when a predetermined time has elapsed without a data communication request from the upper control unit of its own terminal or the base station in the individual control channel connected state, the state control unit may control the state of its own terminal so that the state transits to a sleep state in which a wireless connection of the individual control channel is terminated while maintaining a connection with the base station.

As another preferred example, when there is a termination request from the upper control unit of its own terminal or the base station in the individual control channel connected state, the state control unit may control the state of its own terminal so that the state transits to a standby state by terminating a wireless connection of the individual control channel and a connection with the base station.

As another preferred example, when a communication request is received from the upper control unit of its own terminal or the base station in a sleep state or a standby state in which a connection with the base station is not established, the channel requesting unit may request the base station to allocate the individual control channel.

The present invention also provides a base station including: a channel allocating unit that allocates, in response to a request from the wireless communication terminal, one of the traffic channels as an individual control channel to be exclusively used for the wireless communication terminal.

Typically, the channel allocating unit may have a function that allocates a data communication traffic channel corresponding to the traffic channel as the individual control channel and transmits allocation information of the data communication traffic channel to the wireless communication terminal through the individual control channel.

The present invention also provides a wireless communication method in which a plurality of channels are shared and one of the channels is adaptively allocated to a wireless communication terminal by a base station, the method including: a first step in which the wireless communication terminal requests the base station to allocate an individual control channel when a communication request is received from an upper control unit of its own terminal or the base station; a second step in which the base station allocates one of the traffic channels as the individual control channel to be exclusively used for the wireless communication terminal in response to the request from the wireless communication terminal; and a third step in which the wireless communication terminal controls the state of its own terminal so that the state transits to an individual control channel connected state in which control information is transmitted/received by wirelessly connecting the individual control channel allocated from the base station.

### EFFECT OF THE INVENTION

According to the present invention, in a wireless communication system in which a plurality of channels are shared and one of the channels is adaptively allocated to a wireless communication terminal by a base station, wireless resource allocation control can be performed at a very high speed by allocating one of the traffic channels as an individual control channel to be exclusively used for the wireless communication terminal and setting an individual control channel connected state in which control information is transmitted to and received from the base station in a unit of one frame through the individual control channel as the state of the wireless communication terminal. Consequently, the use efficiency improvement of wireless resources desired by a next-generation broadband mobile communication system can be promoted.

### BRIEF DESCRIPTION OF THE DRAWINGS

FIG. 1 is a configuration block diagram of a wireless communication system having a base station CS and a wireless communication terminal (terminal) T according to one embodiment of the present invention.

FIG. 2 is a schematic diagram showing scheduling of subchannels and slots of the wireless communication system according to the same embodiment.

FIG. 3 is a detailed illustrative diagram of a wireless communication section 2 according to the same embodiment.

FIG. 4 is a state transition diagram of the wireless communication terminal T according to the same embodiment.

FIG. 5 is a flowchart showing a state transition control operation of the wireless communication terminal T according to one embodiment of the present invention.

### REFERENCE SYMBOLS

Cs: base station
T: Wireless communication terminal (Terminal)
1, 10: Control section
2, 11: Wireless communication section
3, 14; Storage section
1a: Communication quality determination section
1b: QoS control section
1c: Scheduler (Channel allocating unit)
12: Operating section
13: Display section
10a: Channel requesting section (Channel requesting unit)
10b: State control section (State control unit)
N: Public line network

### BEST MODE FOR CARRYING OUT THE INVENTION

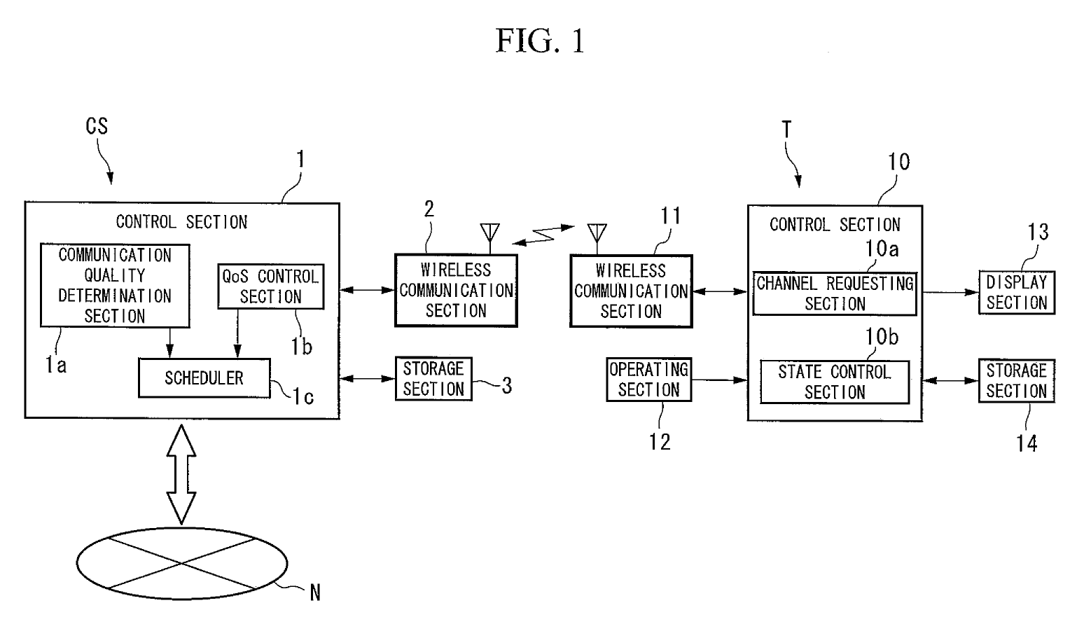

Hereinafter, one embodiment of the present invention will be described in detail with reference to the drawings. FIG. 1 is a block diagram showing main part configurations of a wireless communication system, base station, and wireless communication terminal according to this embodiment. As shown in FIG. 1, the wireless communication system according to this embodiment is provided with a base station CS and a wireless communication terminal T.

For example, a plurality of base stations CS are arranged at regular distance intervals, but only one base station CS is illustrated in FIG. 1 for the sake of simplifying the illustration. The base station CS wirelessly communicates with a plurality of wireless communication terminals T, but one wireless communication terminal T is illustrated in FIG. 1. In the following description, it is assumed that the wireless communication system adopts an orthogonal frequency division multiple access scheme (OFDMA) as a multiple access technology in addition to a time division multiple access scheme (TDMA) and a time division duplex scheme (TDD). In the following, the wireless communication terminal T is referred to as the terminal T.

As shown in FIG. 1, the base station CS is provided with a control section 1, a wireless communication section 2, and a storage section 3, wherein the control section 1 is provided with a communication quality determination section 1a, a QoS control section 1b, and a scheduler 1c (channel allocating unit) as its functional elements. The base station CS is connected to a public line network N, thereby communicating with another base station through the public line network N, a server connected to the public line network N, or the like.

In the base station CS, the control section 1 controls an overall operation of this base station CS on the basis of a base station control program stored in the storage section 3, a reception signal acquired through the wireless communication section 2, or an external signal acquired through the public line network N. In the control section 1, the communication quality determination section 1a determines uplink communication quality on the basis of an SNR (Signal to Noise Ratio) of the reception signal acquired through the wireless communication section 2 or an RSSI (Received Signal Strength Indicator), and outputs the determination result to the scheduler 1c.

On the basis of an application operating in an upper layer protocol or a user priority of the terminal T connected to communication, the QoS control section 1b sends a request to the scheduler 1c by allocating a service class to the terminal T, allocating wireless resources according to the service class, or allocating communication timing. Details will be described later, but the above-described wireless resources are allocated in an OFDMA subchannel (hereinafter, simply referred to as subchannel) unit and the communication timing is allocated in a TDMA slot (hereinafter, simply referred to as a slot) unit.

Based on the service class allocated to the terminal T connected to the communication, a queue state of packets between the base station CS and the terminal T, or the determination result (that is, uplink communication quality) of the above-described communication quality determination section 1a, the scheduler 1c performs a scheduling operation related to subchannel and slot allocations to the terminal T. The scheduler 1c allocates a coding rate or modulation scheme of packets according to the uplink communication quality. Both a downlink slot and an uplink slot are scheduled as slots.

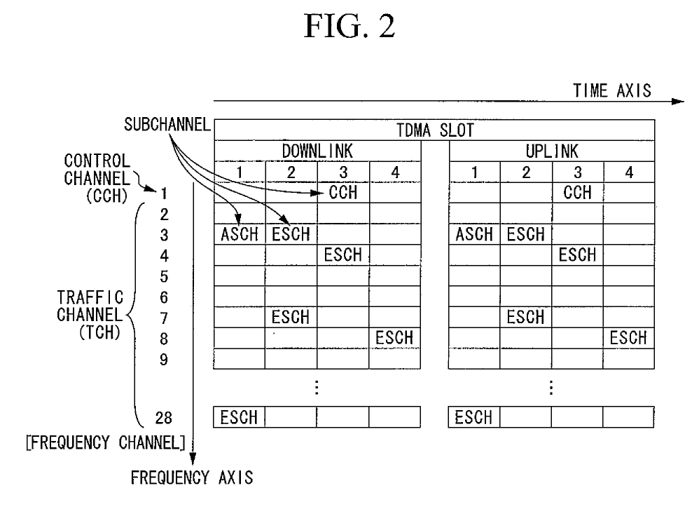

Here, the scheduling of the subchannel, and the downlink and uplink slots in the scheduler 1c will be described in detail. As described above, the OFDMA scheme is a technology that realizes multiple accesses when a plurality of terminals T share subcarriers in an orthogonal relation and a given plurality of subcarriers are adaptively allocated to each terminal T at a given communication timing (this communication timing serves as a slot since TDMA is adopted in this embodiment) and positioned as subchannels. In FIG. 2, there is shown a relation between the subchannels and the TDMA slots. In FIG. 2, the vertical axis represents the frequency and the horizontal axis represents the time.

As shown in FIG. 2, a subchannel in one frequency channel is used as a control channel (CCH) to be commonly referred to by a plurality of terminals T and the remaining subchannels are used as traffic channels (TCHs). As in the conventional PHS (PHS without use of OFDMA), four TDMA slots per frame are arranged for each of the uplink and downlink, and the subchannels are symmetrically used for both the uplink and downlink since TDD is adopted.

In this embodiment, one of the above-described TCHs is allocated as an individual control channel (hereinafter, referred to as anchor subchannel (ASCH)) to be exclusively used for the terminal T. In this embodiment, a TCH capable of being allocated for data communication is referred to as an extra subchannel (ESCH). That is, as in the conventional PHS, the CCH in this embodiment is shared between all base stations and all terminals and a period in which one base station CS can use the CCH is very long (about 100 ms), but the ASCH in this embodiment is allocated from among the TCHs so that it can be used in every frame period (5 ms). Hereinafter, schedule information of the subchannels as shown in FIG. 2 is referred to as MAP.

As in the conventional PHS, the above-described CCH is used for communication of an LCH allocation request and response, a signal reception request to the terminal T, synchronous control information, the system's broadcast information, etc. On the other hand, the above-described ASCH is used for communication of ESCH allocation information.

The control section 1 transmits allocation information of the ASCH and ESCH, the modulation scheme, or the coding rate to the terminal T through the wireless communication section 2 on the basis of scheduling by the scheduler 1c as described above, and controls the wireless communication section 2 to perform modulation and error-correction encoding in the modulation scheme and the coding rate determined by the above-described scheduling.

Under control of the control section 1, the wireless communication section 2 error-correction encodes, modulates, and OFDMA multiplexes a data signal or a control signal output from the control section 1, and transmits a transmission signal to the terminal T after frequency-converting the multiplexed signal (OFDMA signal) into an RF frequency band.

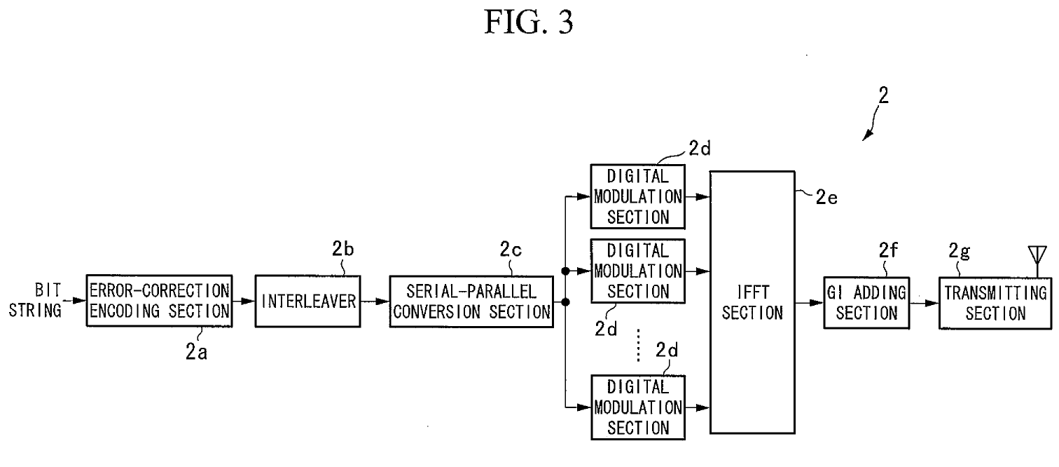

More concretely, a transmitter side of the wireless communication section 2 as shown in FIG. 3 is provided with an error-correction encoding section 2a, an interleaver 2b, a serial-parallel conversion section 2c, a plurality of digital modulation sections 2d, an IFFT (Inverse Fast Fourier Transform) section 2e, a GI (Guard Interval) adding section 2f and a transmitting section 2g.

The error-correction encoding section 2a is, for example, an FEC (Forward Error Correction) encoder to add an error correction code as redundant information to a bit string of a data signal or a control signal input from the control section 1 on the basis of a coding rate allocated by the scheduler 1c and output it to the interleaver 2b. The interleaver 2b performs an interleaving process for the bit string to which the error correction code is added by the above-described error-correction encoding section 2a. The serial-parallel conversion section 2c divides the bit string after the above-described interleaving process in a bit unit for every subcarrier included in the ASCH or ESCH allocated by the scheduler 1e and outputs it to the digital modulation section 2d.

The digital modulation sections 2d whose number is the same as the number of subcarriers are arranged to digitally modulate bit data divided for each subcarrier by using a subcarrier corresponding to the bit data and output a modulation signal to the IFFT section 2e. Each digital modulation section 2d performs digital modulation using a modulation scheme allocated by the scheduler 1c, for example, BPSK (Binary Phase Shift Keying), QPSK (Quadrature Phase Shift Keying), 16QAM (Quadrature Amplitude Modulation), 64QAM, or etc.

The IFFT section 2e generates an OFDMA signal by performing an inverse Fourier transform operation and an orthogonal multiplexing operation on the modulation signal input from each digital modulation section 2d, and outputs the OFDMA signal to the GI adding section 2f.

The GI adding section 2f adds a guard interval (GI) to the OFDMA signal input from the IFFT section 2e and outputs it to the transmitting section 2g.

The transmitting section 2g frequency-converts the OFDMA signal input from the GI adding section 2f into an RF frequency band and transmits a transmission signal to the terminal T.

On the other hand, although not shown, a receiver side of the wireless communication section 2 is provided with components for performing an inverse operation to the above-described transmitter side. That is, the receiver side of the wireless communication section 2 extracts a reception OFDMA signal by frequency-converting a reception signal received from the terminal T into an IF frequency band, removes a guard interval from the reception OFDMA signal, and reconfigures and outputs a bit string to the control section 1 by performing an FFT process, a digital demodulation process, a parallel-serial conversion process, a deinterleaver process, and an error-correction decoding process.

Referring back to FIG. 1, the storage section 3 stores a base station control program to be used in the above-described control section 1 or other various data, and has a function as a buffer to be used for flow control, retransmission control, etc. in the control section 1.

Next, the configuration of the terminal T will be described. As shown in FIG. 1, the terminal T is provided with a control section 10, a wireless communication section 11, an operating section 12, a display section 13, and a storage section 14. The control section 10 is provided with a channel requesting section (channel requesting unit) 10a and a state control section (state control unit) 10b as its functional elements.

In the terminal T, the control section 10 controls an overall operation of the terminal T on the basis of a terminal control program stored in the storage section 13, a reception signal acquired through the wireless communication section 11, or an operation signal input from the operating section 12. In the control section 10, when a communication request is received from an upper control unit of its own terminal (for example, an application of an upper layer protocol operating in the control section 10) or the base station CS, the channel requesting section 10a generates an ASCH allocation request signal for requesting the base station CS to allocate an ASCH and transmits the ASCH allocation request signal to the base station CS through the wireless communication section 11.

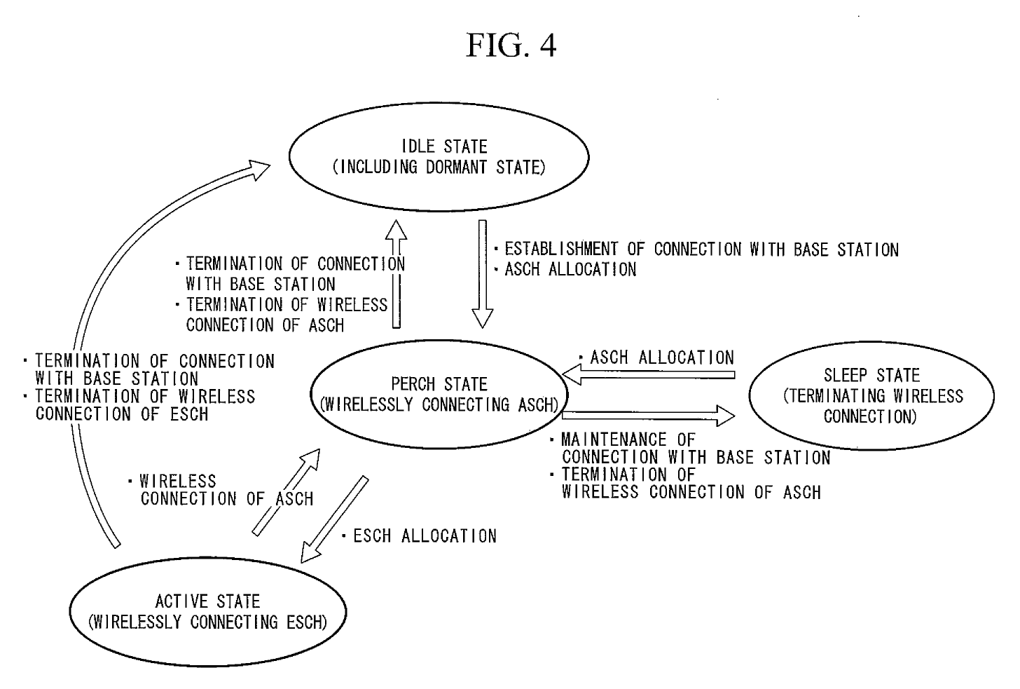

The state control section 10b controls the state transition of the terminal T. Specifically, as shown in the state transition diagram of FIG. 4, the terminal T has four states which are an idle state (standby state), a perch state (individual control channel connected state), an active state (data communication state), and a sleep state, and the above-described state control section 10b controls the transition of the four states on the basis of a reception signal acquired through the wireless communication section 11 and an operation signal input from the operating section 12.

Here, as in the conventional PHS, the idle state is the state (including a dormant state) in which a connection with the base station CS is not established.

The perch state is the state in which the connection with the base station CS is established and the ASCH is wirelessly connected. In other words, the perch state is the state in which control information (that is, including ESCH allocation information) can be transmitted to and received from the base station CS through the ASCH in a unit of one frame.

The active state is the state in which the connection with the base station CS is established and data communication is performed by wirelessly connecting the ESCH.

The sleep state is the state in which the wireless connection of the ASCH is terminated while maintaining the connection with the base station CS.

Details about a state transition control operation in the state control section 10b will be described later.

Referring back to FIG. 1, under control of the control section 10, the wireless communication section 11 error-correction encodes, modulates, and OFDMA-multiplexes a data signal or a control signal output from the control section 10, and transmits a transmission signal to the base station CS after frequency-converting the multiplexed signal (OFDMA signal) into an RF frequency band. A subchannel, a modulation scheme, and a coding rate to be used in the wireless communication section 11 are allocated by the base station CS (specifically, the scheduler 1e). Since the configurations of a transmitter side and a receiver side of the wireless communication section 11 are the same as those of the wireless communication section 2 in the above-described base station CS, their descriptions are omitted.

The operating section 12 is configured from operation keys which are a power key, various function keys, a numeric keypad, etc., and outputs an operation signal based on an operation input by these operation keys to the control section 10.

The display section 13 is, for example, a liquid crystal monitor, an organic EL monitor, etc., and displays a predetermined image on the basis of a display signal input from the control section 10.

The storage section 14 stores a terminal control program to be used in the above-described control section 10 or other various data, and has a function as a buffer to be used for retransmission control, etc.

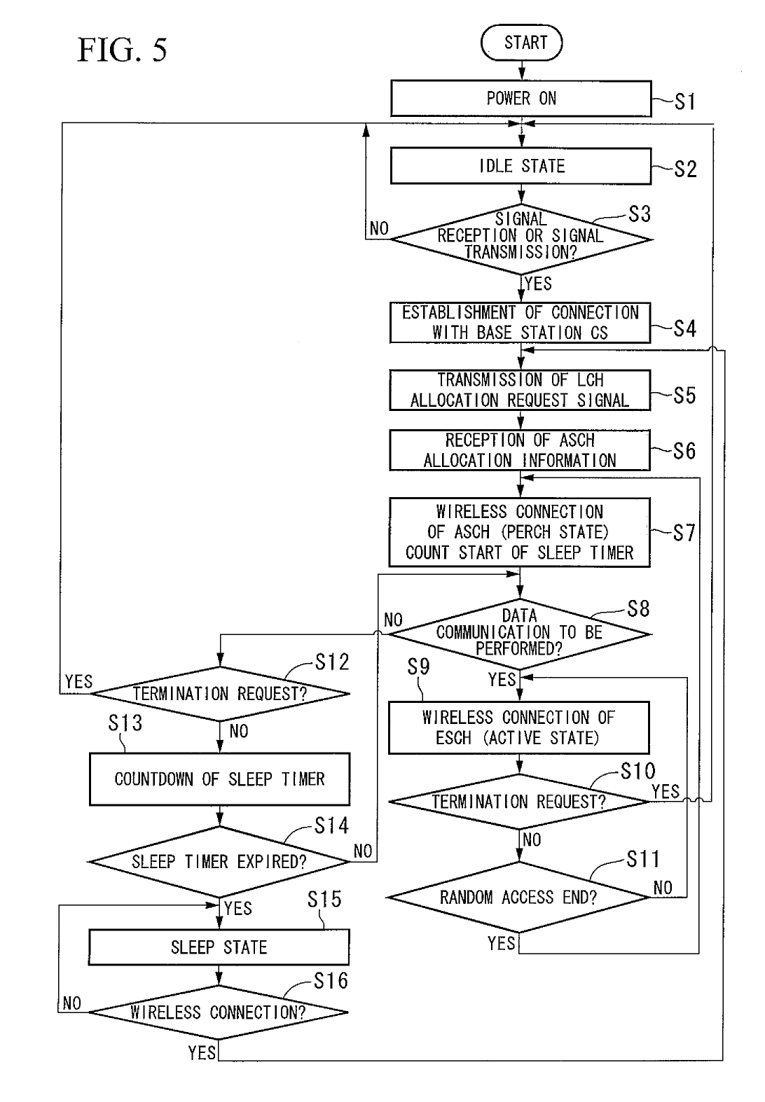

Next, the communication operation between the base station CS and the terminal T in this wireless communication system configured as described above, mainly the state transition control operation of the terminal T, will be described using the flowchart of FIG. 5.

First, when an operation signal indicating power ON is input from the operating section 12, the state control section 10b of the terminal T applies power to its own terminal (step S1), and transits the state of its own terminal to the idle state (step S2). In this idle state, the state control section 10b monitors a signal reception response request included in a downlink CCH transmitted from the base station CS through the wireless communication section 11, monitors a signal transmission request from an upper application of its own terminal (an application operating in the upper layer protocol), and determines whether or not to perform signal reception or signal transmission (step S3).

When it is determined that the signal reception or signal transmission is not performed in the above-described step S3, that is, when the signal reception response request or signal transmission request does not exist (“No”), the state control section 10b returns to the process of step S2 and continues the idle state. On the other hand, when it is determined that the signal reception or signal transmission is performed in step S3, that is, when the signal reception response request or signal transmission request exists (“Yes”), the state control section 10b performs the transmission/reception of a control signal about synchronization with the base station CS, the exchange (negotiation) of various parameters, etc., and establishes a connection with the base station CS (step S4).

When the connection with the base station CS is established as described above, the state control section 10b transmits an LCH allocation request signal using an uplink CCH to the base station CS through the wireless communication section 11 (step S5). On the other hand, when the LCH allocation request signal is received through the wireless communication section 2, the control section 1 of the base station CS commands the scheduler 1c to allocate an ASCH to the terminal T. On the basis of upstream carrier sensing in the base station CS, the scheduler 1c transmits allocation information of the ASCH to the terminal T through the wireless communication section 2 using a downlink CCH after allocating the ASCH to the terminal T.

Then, when the ASCH allocation information is received through the wireless communication section 11 (step S6), the state control section 10b of the terminal T transits the state of its own terminal to the perch state by controlling the wireless communication section 11 to perform a wireless connection of the ASCH allocated from the base station CS (step S7). When the transition to the perch state is made, the state control section 10b starts a count operation of a sleep timer serving as the criterion of timing at which the transition to the sleep state is made.

The state control section 10b determines whether or not to perform data communication in response to a request from the base station CS or the upper application of its own terminal in the perch state (step S8) and transits the state of its own terminal to the active state by performing a wireless connection of an ESCH on the basis of ESCH allocation information included in the ASCH (step S9) when the data communication is performed (“Yes”). The above-described ESCH allocation information is created by the scheduler 1c when a data amount requested from an upper application of its own terminal or a data amount received by the base station CS from the public line network N is detected.

In the above-described active state, the data communication is performed by random access between the terminal T and the base station CS using the ESCH. In this active state, the state control section 10b determines whether or not there is a termination request according to a request from the base station CS or the upper application of its own terminal (step S10), and transits the state of its own terminal to the idle state by performing a termination process of the wireless connection of the ESCH and a termination process of the connection with the base station CS through the wireless communication section 11 (step S2) when the termination request exists (“Yes”).

On the other hand, when the termination request does not exist in the above-described step S10 (“No”), the state control section 10b determines whether or not the data communication by random access ends (step S11). When the data communication by the above-described random access does not end (“No”), the state control section 10b continues the data communication by the random access by returning to step S9.

On the other hand, when the data communication by the random access ends in the above-described step S11 (“Yes”), the state control section 10b transits the state of its own terminal to step S7, that is, the perch state.

At this time, the sleep timer is reset to an initial state and recounted.

When the data communication is not performed in the above-described step S8 (“No”), the state control section 10b determines whether or not there is a termination request according to a request from the base station CS or the upper application of its own terminal (step S12). When there is the termination request (“Yes”), the state control section 10b transits the state of its own terminal to the idle state (step S2) by controlling the wireless communication section 11 to perform a termination process of the wireless connection of the ASCH and a termination process of the connection with the base station CS.

On the other hand, when the termination request does not exist in the above-described step S12 (“No”), the state control section 10b performs the countdown of the sleep timer (step S13) and determines whether or not the sleep timer has expired (for example, the sleep timer by the countdown has become “0”) (step S14).

When the sleep timer has not expired in the above-described step S14 (“No”), the state control section 10b returns to the process of step S8. On the other hand, when the sleep timer has expired (“Yes”), the state control section 10b transits the state of its own terminal to the sleep state by controlling the wireless communication section 11 to terminate the wireless connection of the ASCH and maintain the connection with the base station CS (step S15).

The state control section 10b determines whether or not there is a wireless connection request according to a request from the base station CS or the upper application of its own terminal in the sleep state (step S16), returns to the process of step S5 when there is the wireless connection request (“Yes”), and maintains the sleep state by returning to step S15 when there is no wireless connection request (“No”).

According to this embodiment as described above, wireless resource allocation can be controlled at a very high speed by allocating one of traffic channels as an individual control channel (ASCH) to be exclusively used for the terminal T and setting a perch state in which a control signal (that is, ESCH allocation information) can be transmitted to and received from the base station CS through the ASCH in a unit of one frame (5 ms), as compared to the conventional case where a CCH of a long period (about 100 ms) is used. Consequently, the use efficiency improvement of wireless resources by random access desired by a next-generation broadband mobile communication system can be promoted.

When a predetermined time has elapsed without performing data communication in the perch state, the transition to the sleep state is made and the ASCH is opened (terminated), thereby contributing to the user efficiency improvement of wireless resources. Also, the effect of suppressing power consumption of the terminal T is expected in addition to the use efficiency improvement of wireless resources by opening the ASCH.

In the above-described embodiment, the ESCH allocation information is transmitted and received using the individual control channel (ASCH), but is not limited thereto. Other control information may be transmitted and received using the above-described individual control channel.

In the above-described embodiment, a next-generation broadband mobile communication system adopting orthogonal frequency division multiple access (OFDMA) as a multiple access technology in addition to time division multiple access (TDMA) and time division duplex (TDD) has been illustrated as a wireless communication system, but this wireless communication system is not limited thereto. Any wireless communication system in which a plurality of channels are shared within the system and one of the channels is adaptively allocated to a wireless communication terminal is applicable.

### INDUSTRIAL APPLICABILITY

According to the present invention, in a wireless communication system in which a plurality of channels are shared and one of the channels is adaptively allocated to a wireless communication terminal by a base station, wireless resource allocation can be controlled at a very high speed by allocating one of the traffic channels as an individual control channel to be exclusively used for the wireless communication terminal and setting an individual control channel connected state in which control information is transmitted to and received from the base station through the individual control channel in a unit of one frame as the state of the wireless communication terminal. Consequently, the use efficiency improvement of wireless resources desired by a next-generation broadband mobile communication system can be promoted.

1. A wireless communication system in which a plurality of channels are shared and one of the channels is adaptively allocated to a wireless communication terminal by a base station,
the wireless communication terminal including:
a channel requesting unit that requests the base station to allocate an individual control channel when a communication request is received from an upper control unit of its own terminal or the base station; and
a state control unit that controls the state of its own terminal so that the state transits to an individual control channel connected state in which control information is transmitted or received by wirelessly connecting the individual control channel allocated from the base station; and
the base station including:
a channel allocating unit that allocates one of a plurality of traffic channels as the individual control channel to be exclusively used for the wireless communication terminal in response to the request from the wireless communication terminal.

2. The wireless communication system of claim 1, wherein the channel allocating unit has a function that allocates a data communication traffic channel and transmits allocation information of the data communication traffic channel to the wireless communication terminal through the individual control channel, and
the state control unit controls the state of its own terminal so that the state transits to a data communication state in which data communication with the base station is performed by wirelessly connecting a traffic channel indicated by the traffic channel allocation information obtained through the individual control channel when a data communication request is received from the upper control unit of its own terminal or the base station in the individual control channel connected state.

3. The wireless communication system of claim 2, wherein when the data communication with the base station ends in the data communication state, the state control unit controls the state of its own terminal so that the state transits to the individual control channel connected state.

4. The wireless communication system of claim 2, wherein when there is a termination request from the upper control unit of its own terminal or the base station in the data communication state, the state control unit controls the state of its own terminal so that the state transits to a standby state by terminating a wireless connection of the data communication traffic channel and a connection with the base station.

5. The wireless communication system of claim 1, wherein when a predetermined time has elapsed without a data communication request from the upper control unit of its own terminal or the base station in the individual control channel connected state, the state control unit controls the state of its own terminal so that the state transits to a sleep state in which a wireless connection of the individual control channel is terminated while maintaining a connection with the base station.

6. The wireless communication system of claim 1, wherein when there is a termination request from the upper control unit of its own terminal or the base station in the individual control channel connected state, the state control unit controls the state of its own terminal so that the state transits to a standby state by terminating a wireless connection of the individual control channel and a connection with the base station.

7. The wireless communication system of claim 1, wherein when a communication request is received from the upper control unit of its own terminal or the base station in a sleep state or a standby state in which a connection with the base station is not established, the channel requesting unit requests the base station to allocate the individual control channel.

8. A wireless communication terminal for performing communication by sharing a plurality of channels and adaptively allocating one of the channels from a base station, the terminal comprising:
a channel requesting unit that requests the base station to allocate an individual control channel when a communication request is received from an upper control unit of its own terminal or the base station; and
a state control unit that controls the state of its own terminal so that the state transits to an individual control channel connected state in which control information is transmitted/received by wirelessly connecting the individual control channel allocated from the base station.

9. The wireless communication terminal of claim 8, wherein when a data communication request is received from the upper control unit of its own terminal or the base station in the individual control channel connected state, the state control unit controls the state of its own terminal so that the state transits to a data communication state in which data communication with the base station is performed by wirelessly connecting a traffic channel indicated by traffic channel allocation information obtained through the individual control channel.

10. The wireless communication terminal of claim 9, wherein when the data communication with the base station ends in the data communication state, the state control unit controls the state of its own terminal so that the state transits to the individual control channel connected state.

11. The wireless communication terminal of claim 9, wherein when there is a termination request from the upper control unit of its own terminal or the base station in the data communication state, the state control unit controls the state of its own terminal so that the state transits to a standby state by terminating a wireless connection of the data communication traffic channel and a connection with the base station.

12. The wireless communication terminal of claim 8, wherein when a predetermined time has elapsed without a data communication request from the upper control unit of its own terminal or the base station in the individual control channel connected state, the state control unit controls the state of its own terminal so that the state transits to a sleep state in which a wireless connection of the individual control channel is terminated while maintaining a connection with the base station.

13. The wireless communication terminal of claim 8, wherein when there is a termination request from the upper control unit of its own terminal or the base station in the individual control channel connected state, the state control unit controls the state of its own terminal so that the state transits to a standby state by terminating a wireless connection of the individual control channel and a connection with the base station.

14. The wireless communication terminal of claim 8, wherein when a communication request is received from the upper control unit of its own terminal or the base station in a sleep state or a standby state in which a connection with the base station is not established, the channel requesting unit requests the base station to allocate the individual control channel.

15. A base station comprising:
a channel allocating unit that allocates, in response to a request from the wireless communication terminal of claim 8, one of traffic channels as an individual control channel to be exclusively used for the wireless communication terminal.

16. The base station of claim 15, wherein the channel allocating unit has a function that allocates a data communication traffic channel corresponding to the traffic channel as the individual control channel and transmits allocation information of the data communication traffic channel to the wireless communication terminal through the individual control channel.

17. A wireless communication method in which a plurality of channels are shared and one of the channels is adaptively allocated to a wireless communication terminal by a base station, the method comprising:
a first step in which the wireless communication terminal requests the base station to allocate an individual control channel when a communication request is received from an upper control unit of its own terminal or the base station;
a second step in which the base station allocates one of a plurality of traffic channels as the individual control channel to be exclusively used for the wireless communication terminal in response to the request from the wireless communication terminal; and
a third step in which the wireless communication terminal controls the state of its own terminal so that the state transits to an individual control channel connected state in which control information is transmitted/received by wirelessly connecting the individual control channel allocated from the base station.
